(19) United States
(12) Patent Application Publication
(10) Pub. No.: US 2012/0193166 A1
(43) Pub. Date: Aug. 2, 2012

(54) Descender with Self-Acting Brake

(76) Inventor: Boris Rogelja, Sydney (AU)

(21) Appl. No.: 13/375,272

(22) PCT Filed: Jun. 9, 2010
(86) PCT No.: PCT/AU2010/000714

§ 371 Date: Jan. 30, 2012

(30) Foreign Application Priority Data
Jun. 12, 2009 (AU) 2009902729

(51) Int. Cl. A62B 1/14; A63B 29/02

(52) U.S. Cl. 182/5

(57) ABSTRACT

A descender (5) for use in abseiling or belaying, comprising a base (10) connected to a harness or the like, with first (16) and second (18) spaced projections engaging a rope, the projections (16, 18) both extending normal to the base (10); an arm (12) pivotally mounted to the base (10) at a pivot axis (14), the arm (12) having a third projection (28) for engaging a rope, the projection (28) extending parallel to the pivot axis (14) and being located so that when the arm (12) is pivoted towards the base (10), the third projection (28) is located between the first (16) and second (18) spaced projections, wherein a fourth projection (156) disposed generally between the first (16) and second (18) projections and adjacent an edge of the base (10) separates a portion of rope passing into the descender (5) and around the first (16) and third (18) projections from the portion of the same rope passing out of the descender (5) between the third (28) and second (18) projections.

### CROSS-REFERENCE TO RELATED APPLICATIONS

The present application claims priority from Australian Provisional patent application No 2009902729 filed 12 Jun. 2009 and entitled “Improved Descender” the entire content of which is incorporated herein by reference.

### FIELD OF THE INVENTION

The present application relates to a descender for use in abseiling and belaying and in particular to an improved descender of the type which incorporates a self-acting brake.

### BACKGROUND OF THE INVENTION

Abseiling is a technique used to descend steep surfaces such as cliff faces and is often used by persons involved in activities such as mountain climbing, canyoning and caving. In order to abseil down a cliff face, one end of a rope is made fast at the top of the cliff and the person making descent then slides down the rope. The rope is passed either around the body of the person or, more usually, through a descender attached to a harness worn by the person such that the passage of the rope around the body or through the descender provides sufficient friction to slow the rate of descent to a safe speed.

A descender comprises rope engaging services around and between which the rope travels along a tortuous path, to provide frictional engagement between the rope and the descender. The rate of descent is normally controlled by holding the free or tail end of the rope to control the tension on the rope where it emerges from the descender and thereby to control the degree of friction engagement between the rope and descender which in turn controls the rate of descent.

Descenders used in abseiling vary greatly in performance and complexity, there being a variety of relatively simple devices which rely on frictional engagement between the rope and metal rings or racks about which the rope is wrapped, and a number of more complex descenders which incorporate a braking mechanism which allows friction between the rope and descender to be varied other than by simply controlling the free or tail end of the rope. The earliest of these more complex devices have a handle or lever which when operated tended to increase the friction between the descender and the rope. This type of descender was not a great improvement over the more simple devices as the brake was not self engaging and therefore, if the user was knocked unconscious, he or she would fall in the same way as a user of the earlier devices.

A number of devices now include automatic braking mechanisms in which a handle is operated by a person using descender to control their speed of descent and if the handle is released a brake actuates and prevents a user falling uncontrollably. Australian Patent Application No 16132/95 discloses such a descender which provides an automatic locking system for the descender operated by a lever, in which operation of the lever by a person using the descender releases a braking means and allows the person to descend, and in which should the person using descender release the lever, the braking system will automatically apply and prevent the person falling uncontrollably.

A similar type of descender is disclosed in U.S. Pat. No. 4,596,314.

There are two problems associated with the descenders of the type shown in AU 16132/95. The first problem is that the descender cannot be used for belaying. Belaying is a well known technique, used in climbing. A climber (the belayee) will descend or climb a cliff face, or the like, while roped to the cliff face via pitons. A belayer will hold the rope and allow the belayee only as much rope as he or she requires in order to move a short distance up or down the cliff face. Thus, if the belayee falls their fall will be arrested by the rope and the belayer. However, descenders such as that shown in AU 16132/95 cannot be used for belaying.

A second disadvantage of the descender described in AU 16132/95 is that the rate of descent cannot be preselected by a person using the device as a descender.

International Patent Application No PCT/AU97/00147 discloses an improved descender with an automatic braking means that allows it to be used as a descender for use in abseiling, or belaying. However, a problem with the descender is that it does not function effectively, when used as an ascender to raise an object, body or the like, and has a tendency to jam.

The present invention aims to alleviate the above mentioned problems of PCT/AU97/00147.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

Thus, according to the present invention there is provided a descender for use in abseiling, or belaying, comprising:

a base having a connection means for connecting the descender to a harness or the like;

an arm pivotally mounted on the base at a pivot axis extending generally normal to the base;

the base having first and second spaced projections for engaging a rope, the projections both extending generally parallel to the pivot axis;

the arm having a third projection for engaging a rope, the projection extending generally parallel to the pivot axis, the projection being located so that when the arm is pivoted towards the base the projection is located to one side of a longitudinal axis passing through the first and second spaced projections on the base and is spaced further from the pivot axis than the second projection, but closer to the pivot axis than the first projection, and

a retention plate; characterised by:

a fourth projection disposed generally between the first and second spaced projections and adjacent an edge of the base located so as to separate a portion of rope passing into the descender around the first projection and around the third projection from the portion of the same rope passing out of the descender between the third and second projections.

Typically, the fourth projection is mounted on the end of an arm pivoted to the base for movement between a first operative position adjacent the first projection and a second non-operative position.

The projections will typically be sheaves. Typically the first second and third projections will be of generally similar size of the order of 3 cm in diameter while the fourth projection will be relatively smaller and about 1 cm in diameter

Advantageously, as well as being capable of operating as a normal descender and as a belay, the descender of the present invention may also be used to pull a person or object upwards for example out of a shaft up a face of a cliff, building or the like. In this case one end of a rope threaded through the descender is securely attached to the top of the shaft, cliff face etc. and the descender is fixed to a harness worn by the person being raised. The free end of the rope is held by a person at the top of the shaft, cliff or the like pulling the person/object upwards. The person at the top of the cliff can pull the rope upwards in the direction B (shown in FIG. 1B below) and the rope will travel through the descender in that direction, without jamming as the fourth projection keeps the parts of the rope entering and leaving the descender apart and prevents them from rubbing against each other.

In a preferred embodiment, the descender may also include means for biasing the arm to rotate about the pivot away from the base, and stop means for preventing the arm from pivoting further than a predetermined angle away from the base; and

second stop means for restricting the distance the arm can travel towards the base when the biasing means is overcome and the arm pivoted towards the base, said second stop means being adjustable;

the arrangement being such that, in use, with a rope passing below the first projection, above and around the third projection and above the second projection, the resistance force applied to the rope is a maximum when the arm is pivoted so that the third projection is closest to the longitudinal axis, the descender being operable in two modes:—

a first mode in which the descender operates as a descender for controlling the rate of descent of a person sliding down the rope, in which mode the adjustable second stop means can be used to control the rate of descent; and

a second mode wherein the descender is used as a belay with substantially no tension on the rope passing through the descender, such that rope can be fed through the descender, in which mode the biasing means keep the arm and base apart to allow rope to be fed through the descender relatively freely, but in which mode sudden increases in tension in the rope, cause the biasing means to be overcome and the pivot arm to be pulled towards the base thus locking the rope between the first and second projections and preventing uncontrolled descent.

In this embodiment the descender may be used either as a belay or as a descender.

When used as a belay the device allows a rope to run freely through it provided that movements are slow. If the rope starts to move quickly through the descender which would happen if the belayee fell, the arm is pulled towards the base and the device automatically locks. When used as a descender, the adjustable second stop means can be used to control rate of descent.

The automatic braking occurs when pressure is placed on the rope between fixed end sheaves (defined by the first and second projections) and the pivotable centre sheave, defined by the third projection.

In a preferred embodiment, the biasing means comprise a spring acting on a protrusion defined on the arm and the stop means is a catch defined on the base, the catch being movable to allow the descender to be opened.

In one embodiment, the adjustable stop means comprises:

a lever pivoted on the base, said lever being associated with a cam and defining a cam surface;

a cam follower being located on the arm; said cam and cam surface being configured such that when the cam is positioned at either end of the cam surface, the arm can pivot closer to the base than when the cam is in a more central location on the cam surface than when the cam is located at either end of the cam follower, so that in use the resistance force applied to the rope is a maximum when the cam is disposed at or close to either end of the cam surface and a minimum when the cam is disposed between the ends of the cam surface, such that by manipulating the lever the resistance to movement may be set by locating the cam on a particular area on the cam follower and wherein if the handle is not locked in position, sudden movements of the rope through the descender cause the pivot arm to be pulled towards the base thus locking the rope between the first and second projections the lever is lockable in position.

This allows the rate of descent to be preset.

In a preferred embodiment, the lever includes an extension arm which is hinged to the lever which can be folded to the lever for storage and extended for use to increase the effective length of the lever.

Where the descender includes automatic stop means of one type or another, and is fixed to a harness worn by a person, it is also possible for that person to pull themselves up a face of a cliff, building or the like, by pulling on the rope and pulling themselves upwards. The descender moves upwards on the rope and when the person lets go of the rope, the automatic stop means lock and prevent the descender moving downwards on the rope. When the fourth sheave is in an operative position it prevents jamming, as the fourth projection keeps the parts of the rope entering and leaving the descender apart and prevents them from rubbing against each other when the person hauls themselves up the rope.

### BRIEF DESCRIPTION OF THE DRAWINGS

The invention will now be described, by way of example only, and with reference to the accompanying drawings, in which:—

FIG. 1 is a schematic plan view of a first embodiment of a descender, with a retention plate removed;

FIG. 1A is a plan view similar to that of FIG. 1, which illustrates a rope passing through the descender of FIG. 1, in a first configuration for abseiling;

FIG. 1B is a plan view similar to that of FIG. 1, which illustrates a rope passing through the descender of FIG. 1, in a second configuration for ascending;

FIG. 1C is a cross-sectional view along line IC-IC of FIG. 1;

FIG. 2 illustrates a base plate of the descender and a number of components associated with, or attached to, that base plate;

FIG. 2A is a cross-sectional view along line IIA-IIA of FIG. 2;

FIG. 3 illustrates an arm of the descender;

FIG. 3A is a cross-sectional view on line IIIA-IIIA of FIG. 3;

FIG. 4 is an end view of a lever of the descender and associated components; and

FIG. 5 shows a retention plate and the lever of FIG. 4.

### DETAILED DESCRIPTION OF PREFERRED EMBODIMENT

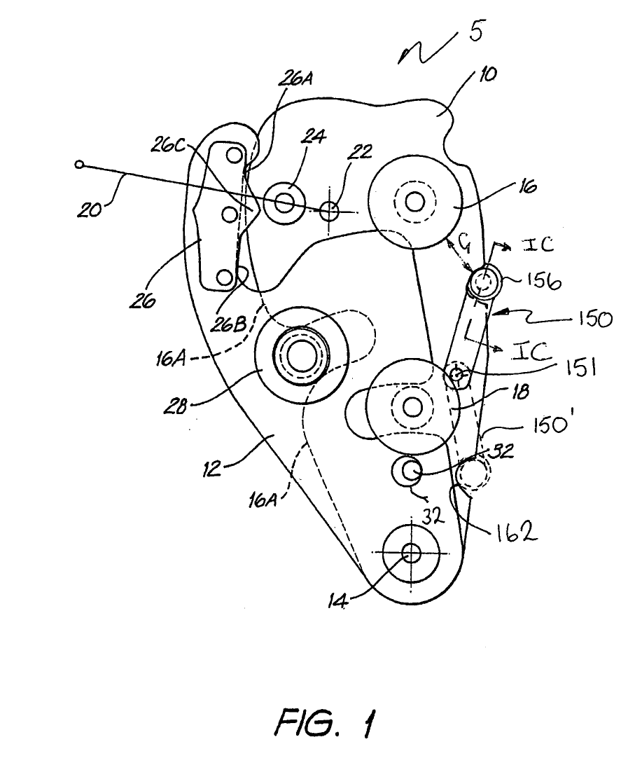

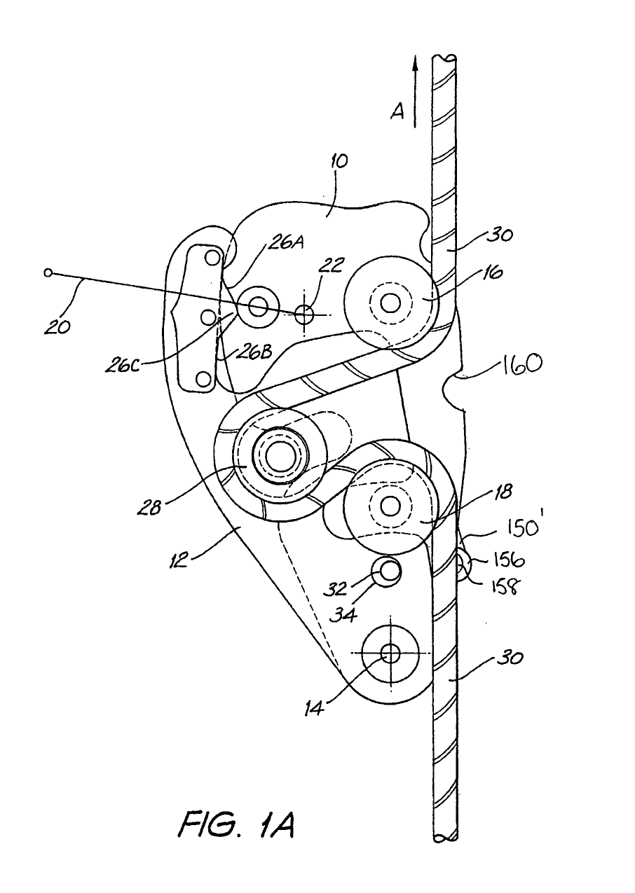

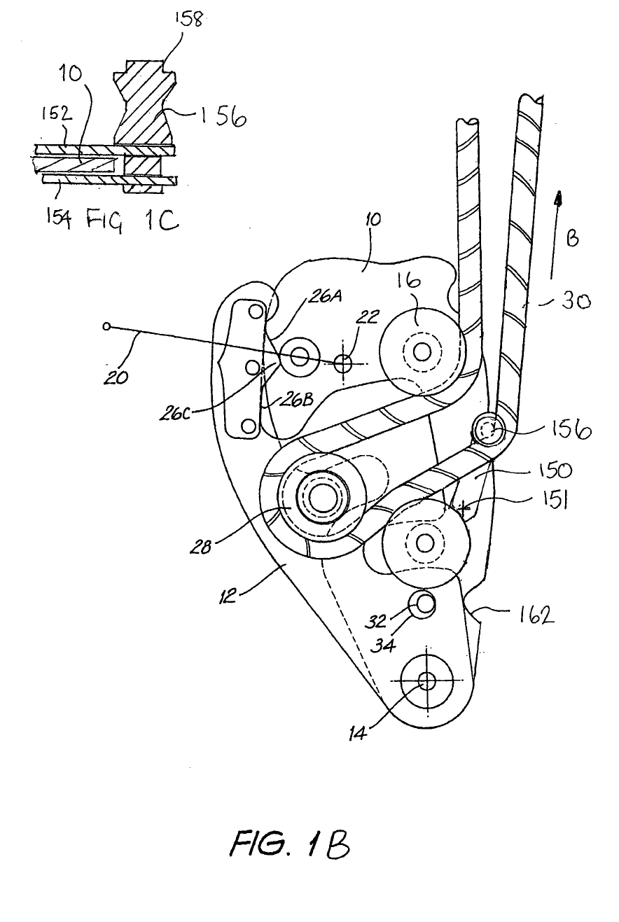

Referring to the drawings, FIG. 1 is a plan view of a descender which includes a base plate 10 and an arm 12. In FIG. 1, the parts, 16A of the outer edge of the base plate which are hidden from view by the arm, are shown in phantom, as are parts of the perimeter of the arm which are hidden from view by sheaves.

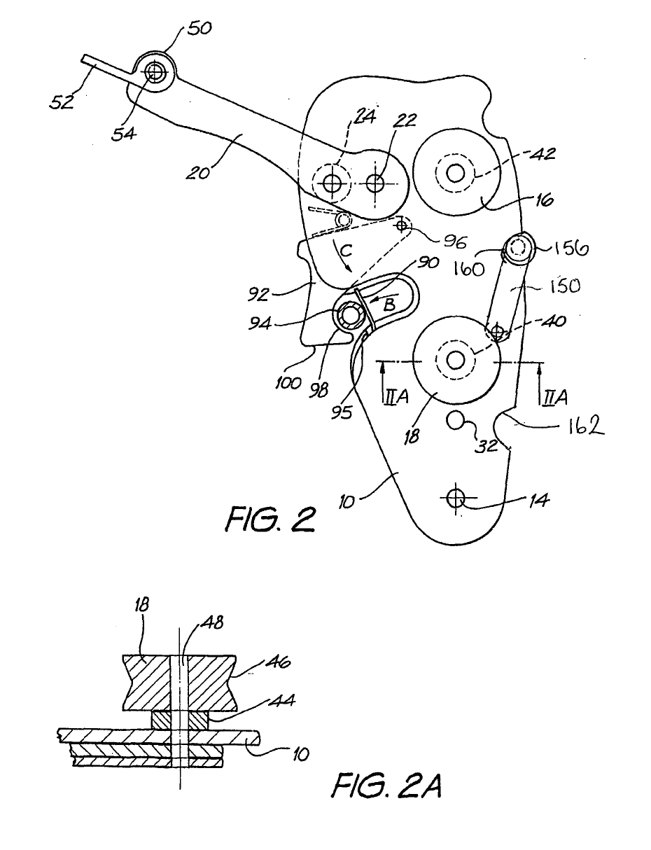

The arm 12 is mounted above the base plate 10 by means of a pivot 14, so that the arm is free to rotate relative to the base plate about that pivot. First and second spaced sheaves, 16 and 18, respectively, are mounted on the base plate. The sheaves are non-rotatable. The sheaves are configured so that parts of the arm 12 can be interposed below the sheaves, between the sheaves and the base 10, as will be explained later with particular reference to FIG. 2A.

A lever 20 is also mounted to the base plate by means of a pivot 22. In FIGS. 1,1A and 1B, the lever is represented by line 20, to avoid obscuring other components of the descender. A cylindrical bearing 24 which defines a cam, is attached to the lever 20, adjacent the pivot. A cam surface/cam follower 26 is riveted to the arm. When the cam 24 is in contact with the cam surface 26, pivoting the lever 20 about the pivot 22 moves the bearing surface 24 relative to the cam surface 26 and the arm is, in consequence, moved about the pivot 14, to move the arm towards, or away from, the base 10. Consequently sheave 28, which is mounted on the arm 12, moves towards, or away from, sheave 18. As can be seen in FIG. 1, the centre 26C of the cam surface 26, is closer to the pivot 22, than the ends 26A, 26B of the cam surface. Thus when the cam is located at the centre of the cam surface 26C, the arm 12 is further away from the base than when the cam moves to either end 26A or 26B of the cam surface.

A spring and stop arrangement, not illustrated in FIG. 1, is provided which acts on sheave 28 to cause the sheave to move away from sheaves 16 and 18, which in turn causes the arm to rotate anti-clockwise, as illustrated, about pivot 14, away from the base, with the stop preventing arm 12, and hence sheave 28 from moving more than a predetermined angle about the pivot 14 away from the base 10. Thus, in the absence of any other forces, the arm will be held at a predetermined angle relative to the base.

The arm 12 can be locked to the base plate 10 by passing a bolt, or similar device, through small, aligned, holes 30 and 32 in the base plate and retention plate respectively and larger hole 34 in the arm which allows limited movement of the arm about the pivot. This feature is particularly useful if children are using the descenders to prevent them being opened in use, which would be dangerous.

Also shown in FIG. 1 is an arm 150. One end of the arm 150 is mounted about a pivot 151 to the base plate 10 adjacent the second sheave 18. As is best seen in FIG. 1C, the arm 150 includes two parallel plates 152, 154, one of which is located on each side of the base plate 10. The free end of the arm 150 defines a cylindrical sheave 156 having a relatively small diameter (about 1 cm) compared to the sheaves 16, 18, 28 (about 3 cm). The sides of the sheave 156 define a shallow V-shaped profile. The top of the sheave defines a cylindrical protrusion 158.

With reference to FIGS. 1, 1A and 1B in particular, it can be seen that the edge of the base plate 10 defines two generally semicircular recesses/cut outs 160, 162 which are equidistant from the arm's pivot 151. As is best seen in FIG. 1, the arm 150 can be positioned so that the protrusion 158 sits in the cut out 160 so that the sheave 156 is positioned close to the fixed sheave 16. In that position, as shown in FIG. 1, the centre of the sheave 156 is about 3 to 4 cm from the centre of sheave 16 and there is a gap G of about 1.5 to 2.0 cm, typically about 1.8 cm between the external surfaces of the sheaves 16 and 156.

FIG. 1 also shows the arm 150′ in dashed outline showing that it may be rotated about the pivot to a second, lower position where, for convenience, the protrusion locates in the cut out 162. The arm has no function when in the second position and may be moved there when it is not required, e.g. when abseiling as will be described below.

FIG. 1A shows similar a view to FIG. 1 but in which a rope 30 has been threaded through the descender. The descender is shown as it would be oriented in use when attached to a persons harness, attachment means for doing this normally being provided close to the pivot pin 14. The means for attaching a harness typically comprise a hole or aperture 34 through which a karabiner (not shown) attached to a harness (not shown) may pass. Tension in the rope caused by the weight of the person attached to descender tends to pull the spool 28 towards spool 16 thus compressing the rope between spools 16 and 28 and slowing the rate of descent. Moving the lever 20 to cause the cam 24 to move away from either end 26A or end 26B of the cam follower towards the centre 26C of the cam follower, forces the arm 12 to move away from the base 10 thus increasing the distance between sheaves 18 and 28 and allowing the rope to pass more freely between the spools, thus increasing the rate of descent. The rate of descent can thus be controlled by the lever 20. The fact that the central position of the lever 26C provides the fastest rate of descent makes the device inherently safe, since once the lever is above or below the centre 26C the speed of descent is automatically reduced regulating a safe descent rate If the lever is accidentally knocked the likelihood is that it will be knocked, towards one of the ends thus slowing the rate of descent.

When descending/abseiling, as shown in FIG. 1A the sheave 156 is not required and is typically pivoted out of the way to the second position 150′.

The device can also be used as a belay for use in descending or ascending a mountain, cliff face or the like in which case part of the rope will be securely attached to a mountain or cliff face and a person also attached to the rope, the belayer, will feed a limited amount of rope to the belayee as the belayee climbs up or down. The belayer, who may be on the cliff face above or below the belayee or standing at the top or bottom of the cliff face, wears the descender attached to a harness. The spring and stop mechanism keeps the arm 12 apart from the base 10, thus keeping sheaves 28 and 16 apart and allowing the rope to run relatively freely through the descender so that rope is supplied as the belayee/climber requires it hence the belayee can climb freely. If the belayer is also on the cliff face the belayer does not need to use their hands to feed rope to the belayee and can use both hands to grip the cliff face. If the belayer falls the increased tension in the rope will easily overcome the biasing spring and the arm will move towards the base to slow, and regulate, the rate of descent.

To lower the belayee, the belayer can simply operate the lever 20 to control the descent of the belayee.

In a similar arrangement shown in FIG. 1B, the device may also be used to pull a person or object upwards for example out of a shaft up a face of a cliff, building or the like. In this case one end of the rope is securely attached to the top of the shaft, cliff face etc. . . . and the descender is carried on the harness of the person being raised. Typically the person will first have descended or been belayed down the cliff. the free end of the rope is held by the person located at the top of the cliff or the like. If it is not already in position, the arm is moved to the first position so that the small sheave 156 is in the upper position near the sheave 16. In this arrangement the person at the top of the cliff can pull the rope upwards in the direction B and the rope will travel through the descender in that direction, without jamming. If rope is let go of the descender will lock.

It is also possible for a person wearing the harness to which the descender is attached, to pull themselves up a face of a cliff, building or the like, by pulling on the rope and pulling themselves upwards. The descender moves upwards on the rope and when the person lets go of the rope, the stop means lock and prevent the descender moving downwards on the rope. When the fourth sheave is in an operative position it prevents jamming as the fourth projection keeps the parts of the rope entering and leaving the descender apart and prevents them from rubbing against each other when the person hauls themselves up the rope.

It is to be noted that if the sheave 156 is not in position, and the rope is pulled upwards in the direction B, the part of the rope which travels downwards into the descender will contact and rub against the rope as it passes put of the descender adjacent the sheave 16 as the sheave 156 is not present to keep them separate. Pulling on the rope in the direction B in that case tends to pull the arm 12 clockwise and jams the rope in the descender preventing the rope form being pulled through.

The sheave 156 obviates this problem by keeping the two sections of the rope apart and generally parallel but separate, as shown in FIG. 1B.

Having described the general features and principal of operation of the descender, some specific features of the descender particularly relating to the construction of the descender will now be described in more detail with reference to FIGS. 2 to 5A.

FIG. 2 shows a base plate 10 with sheaves 16 and 18 and lever 20 attached. As can be seen from FIG. 2 and FIG. 2A the spools are generally circular in plan view having a reduced diameter portion 44 adjacent the base 10, and a wider cylindrical part 46 whose sides define a shallow V-shaped profile or channel 46. The cut out portion 44 allows parts of the arm 12 to pass under the main part of the sheave 46. The V shaped profile/channel of the wider part of the sheave 46 is configured to receive the rope 30. As shown in FIG. 2A the sheave includes a central longitudinal bore 48 which can receive a rivet or the like to secure the sheave between the base plate 10 and the retention plate, not shown in FIG. 2A.

FIG. 2 also shows that one end of the lever 50 has an extension portion 52 mounted to it which can be rotated about pivot 54 to extend the effective length of the lever.

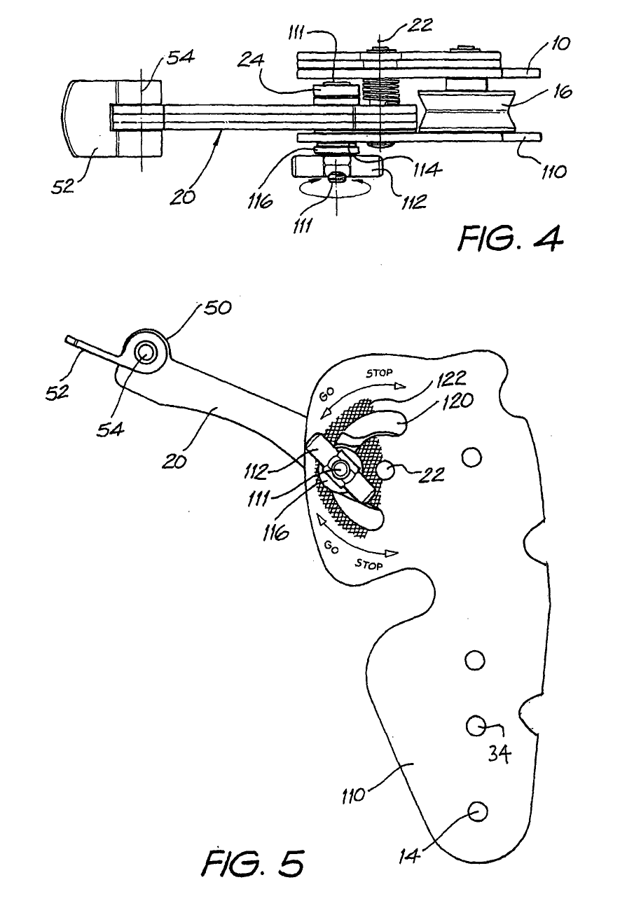

Also shown in FIG. 2 is a spring and stop means assembly for biasing the arm for belaying, and for “opening” and “closing” the descender. The spring and stop means assembly comprises a spring 90, and a catch 92 which are mounted on the underside of the base 10 and a rod 94 which depends from the lower face of the arm 12. The spring is a resilient length of springy steel which is fixed to the base, pushes against a stop 95, and when pushed away from the stop 95 by rod 94, acts to push rod 94 anti-clockwise about pivot 96 on which the catch is mounted, in the direction of the arrow B. The catch is mounted on the underside of base 10, and partly covered by a plate 115, seen in FIG. 4. It is lightly biased to turn in the direction of the arrow C. The inside surface 98 of the catch is configured with a curve of a short radius so as to retain the rod, so that if the rod is pushed in the direction B the catch will not move. To move the catch it is necessary to push on surface 100. That arrangement prevents the descender from accidentally springing open. The descender is opened to allow rope to be fed into the descender and around sheave 28, for use.

The configuration of the surface 100 and location of pivot 96 are such that as the arm is closed, rod 94 pushes the catch clockwise about pivot 96 to open the catch automatically.

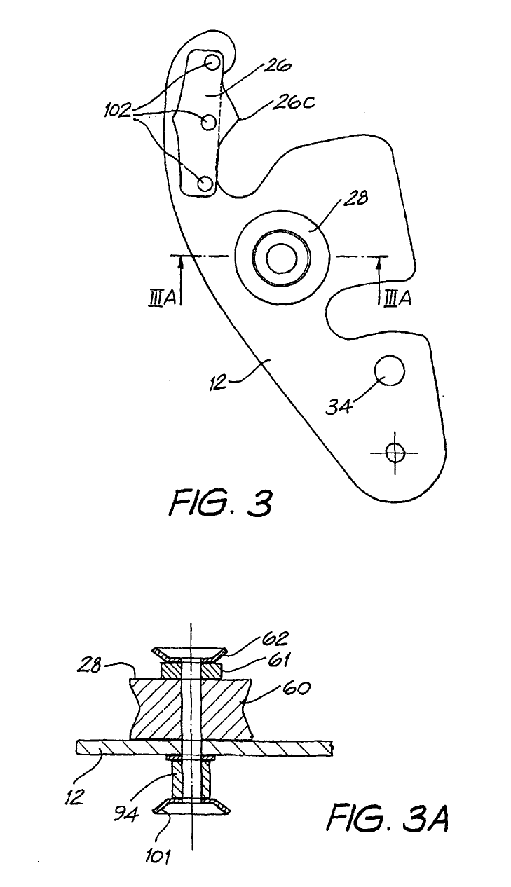

FIG. 3 shows the arm 12 in more detail, and in particular shows the cam follower 26 which is a piece of hardened steel secured to the arm by means of three rivets 102.

FIG. 3A shows the sheave 28 in more detail. The major part 60 of the sheave adjacent the arm 12 is generally cylindrical with the sides of the cylinder having a generally V-shaped profile 60 thus defining a shallow channel to receive the rope. The upper part of the sheath 61 defines a cylindrical portion having a reduced diameter compared to the major part of the sheath which is adapted to locate in a cut out portion of the retention plate to allow the arm and base to close together when assembled. The uppermost part of the sheave defines a wider flange portion 62. On the opposite side of the arm to the sheave is cylindrical rod 94, which terminates in a flange 101.

FIG. 4 shows an end view of the descender illustrating the lever 20 sandwiched between base plate 10 and a retention plate 110. The lever is formed from three sheets of steel sandwiched together although the lever could be made in one piece. In particular, FIG. 4 shows the cam 24 disposed on the underside of the handle as oriented in FIG. 4. The pivot axis 22 of the lever is defined by a rivet/bolt. The cam 24 is disposed on the lower end of a threaded bolt 111. The bolt passes through the lever 20 and a crescent shaped aperture in the retention plate, seen in FIG. 5. An optional wing nut 112 is mounted on the upper end of the bolt 111. Between the wing nut and the upper surface of the retention plate, there is a metal washer 116 and a leather washer 114. The wing nut can be tightened on the rod to compress the leather washer between the nut 112 and the plate 110, and lock the lever to prevent the same from moving. Other embodiments may omit the lever locking function.

Referring now to FIG. 5, which illustrates the retention plate 110, and lever in particular, omitting other features, an arcuate cut out portion 120 is defined in the retention plate through which the threaded rod 111 extends such that the lever can be locked in position anywhere on the arc 120. A roughened portion 122 exists around the cut out 120 to improve the grip of the leather washer on the plate 110.

Because the lever can be locked in position the rate of descent can be preset by an operator. The preset rate of descent can be overridden by operation of the lever.

The spring and stop arrangement allow the descender to be used for belaying by keeping the arm and base apart and preventing locking of the rope when movement of the rope through the descender is slow.

As discussed above the sheave 156 allows the descender to be used to raise a person or object by keeping the two sections of the rope apart and generally parallel but separate, as shown in FIG. 1B. Another factor which is thought to play a part in enabling the descender to work when raising a person or object is that the descender will tend to twist or rotate on the harness and causing its centre of gravity to change.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A descender for use in abseiling or belaying, comprising:
a base configured and arranged to be operatively connected to a harness or the like;
an arm pivotally mounted on the base at a pivot axis extending generally normal to the base;
the base having first and second spaced projections for engaging a rope, the projections both extending generally parallel to the pivot axis;
the arm having a third projection for engaging the rope, the projection extending generally parallel to the pivot axis, the projection being located so that when the arm is pivoted towards the base the projection is located to one side of a longitudinal axis passing through the first and second spaced projections on the base and is spaced further from the pivot axis than the second projection, but closer to the pivot axis than the first projection; and
a retention plate including a fourth projection disposed generally between the first and second spaced projections and adjacent an edge of the base located so as to separate a portion of the rope passing into the descender around the first projection and around the third projection from the portion of the rope passing out of the descender between the third and second projections.

2. A descender as claimed in claim 1 wherein the fourth projection is mounted on an end of a second arm pivotally connected to the base for movement between a first operative position adjacent the first projection and a second, non-operative, position.

3. A descender as claimed in claim 1 wherein the projections are sheaves.

4. A descender as claimed in claim 3 wherein the first, second and third projections are of generally similar diameter, typically of the order of about 3 cm and wherein the diameter of the fourth projection is relatively smaller than that of the first, second and third projections and is typically about 1 cm in diameter.

5. A descender as claimed in claim 1, further comprising:
a spring operatively connected to the base and configured and arranged to bias the arm to rotate about the pivot axis away from the base;
a catch operatively connected to the base and configured and arranged to prevent the arm from pivoting further than a predetermined angle away from the base;
a lever operatively connected to the base;
a cam operatively connected to the lever and defining a cam surface;
a cam follower operatively connected to the arm, the cam and the cam follower configured and arranged to restrict the distance the arm can travel towards the base when a biasing force of the spring is overcome and the arm is pivoted towards the base, the distance the arm is restricted being adjustable;
wherein the rope passes below the first projection, above and around the third projection and above the second projection, a resistance force applied to the rope is a maximum when the arm is pivoted so that the third projection is closest to the longitudinal axis, the descender being operable in two modes:
a first mode in which the descender operates as a descender for controlling the rate of descent of a person sliding down the rope, in which mode the cam and the cam follower are used to control the rate of descent; and
a second mode wherein the descender is used as a belay with substantially no tension on the rope passing through the descender, such that the rope can be fed through the descender, in which the spring keeps the arm and the base apart to allow the rope to be fed through the descender relatively freely, but in which sudden increases in tension in the rope cause the biasing force of the spring to be overcome and the pivot arm to be pulled towards the base thus locking the rope between the first and second projections and preventing uncontrolled descent.

6. A descender as claimed in claim 5 wherein the spring acts on a protrusion defined on the arm and the catch is movable to allow the descender to be opened.

7. A descender as claimed in claim 5 wherein
said lever pivots relative to the base,
said cam and said cam surface being configured such that when the cam is positioned at either end of the cam surface, the arm can pivot closer to the base than when the cam is in a more central location on the cam surface than when the cam is located at either end of the cam follower, so that in use a resistance force applied to the rope is a maximum when the cam is disposed at or close to either end of the cam surface and a minimum when the cam is disposed between the ends of the cam surface, such that by manipulating the lever a resistance to movement is set by locating the cam on a particular area on the cam follower and wherein if the lever is not locked in position, sudden movements of the rope through the descender cause the pivot arm to be pulled towards the base thus locking the rope between the first and second projections and the lever is lockable in a position.

8. A descender as claimed in claim 5 wherein the lever includes an extension arm which is hinged to the lever which can be folded to the lever for storage and extended for use to increase the effective length of the lever.

9. A descender as claimed in claim 1 wherein the distance between the first and the fourth projections is from about 1.5 to 2.0 cm.

10. (canceled)

11. A descender for use in abseiling or belaying with a rope, comprising:
a base configured and arranged to be operatively connected to a harness or the like;
an arm pivotally mounted on the base at a pivot axis extending generally normal to the base;
the base having first and second spaced projections for engaging the rope, the projections both extending generally parallel to the pivot axis;
the arm having a third projection for engaging the rope, the projection extending generally parallel to the pivot axis, the projection being located so that when the arm is pivoted towards the base the projection is located to one side of a longitudinal axis passing through the first and second spaced projections on the base and is spaced further from the pivot axis than the second projection, but closer to the pivot axis than the first projection;
a spring operatively connected to the base and configured and arranged to bias the arm to rotate about the pivot axis away from the base;
a catch operatively connected to the base and configured and arranged to prevent the arm from pivoting further than a predetermined angle away from the base;
a lever operatively connected to the base, a cam operatively connected to the lever and defining a cam surface, and a cam follower operatively connected to the arm, the cam and the cam follower configured and arranged to restrict the distance the arm can travel toward the base when a biasing force of the spring is overcome and the arm is pivoted toward the base, the distance the arm is restricted being adjustable;
wherein the rope passes below the first projection, above and around the third projection, and above the second projection;
wherein a resistance force applied to the rope is a maximum when the arm is pivoted so that the third projection is closest to the longitudinal axis; and
wherein the descender is operable in two modes including a first mode and a second mode, the first mode allowing the descender to operate as a descender for controlling a rate of descent of a person sliding down the rope, the cam and the cam follower being used to control the rate of descent, the second mode allowing the descender to be used as a belay with substantially no tension on the rope passing through the descender such that the rope can be fed through the descender, the spring keeping the arm and the base apart to allow the rope to be fed through the descender relatively freely but a sudden increase in tension in the rope causes the biasing force of the spring to be overcome and the pivot arm to be pulled toward the base thereby locking the rope between the first and second projections and preventing uncontrolled descent.

12. The descender of claim 11, further comprising a retention plate including a fourth projection disposed generally between the first and second spaced projections and adjacent an edge of the base configured and arranged so as to separate a portion of the rope passing into the descender proximate the first projection and proximate the third projection from the portion of the same rope passing out of the descender between the third and second projections.

13. The descender of claim 12, wherein the fourth projection is mounted on an end of a second arm pivotally connected to the base for movement between a first operative position adjacent the first projection and a second, non-operative, position.

14. The descender of claim 11, wherein the spring acts on a protrusion defined on the arm and the catch is movable to allow the descender to be opened.

15. The descender of claim 11, wherein said lever pivots relative to the base, said cam and said cam surface being configured and arranged such that when the cam is positioned at either end of the cam surface, the arm can pivot closer to the base than when the cam is in a more central location on the cam surface, wherein in use a resistance force applied to the rope is a maximum when the cam is disposed proximate either end of the cam surface and a minimum when the cam is disposed between the ends of the cam surface, such that by manipulating the lever a resistance to movement may be set by locating the cam on a particular area on the cam follower and wherein if the lever is not locked in position, a sudden movement of the rope through the descender causes the arm to be pulled toward the base thus locking the rope between the first and second projections, and wherein the lever is lockable in a position.

16. The descender of claim 11, wherein the lever includes an extension arm hingedly operatively connected to the lever which can be folded to the lever for storage and extended for use to increase the effective length of the lever.
